(19) United States
(12) Patent Application Publication
(10) Pub. No.: US 2005/0201594 A1
(43) Pub. Date: Sep. 15, 2005

(54) Movement evaluation apparatus and method

(76) Inventors: Katsuhiko Mori, Kanagawa-ken (JP); Masakazu Matsugu, Chiba-ken (JP); Yuji Kaneda, Fukuoka-ken (JP)

Correspondence Address: Cowan, Liebowitz & Latman, P.C., 1133 Avenue of the Americas, New York, NY, 10036-6799, US

(21) Appl. No.: 11/065,574

(22) Filed: Feb. 24, 2005

(30) Foreign Application Priority Data
Feb. 25, 2004 (JP) 2004-049935(PAT.)

(51) Int. Cl. G06K 9/00

(52) U.S. Cl. 382/107; 348/136

(57) ABSTRACT

A movement evaluation apparatus extracts feature points from a first reference object image and an ideal object image which are obtained by sensing an image including an object by an image sensing unit, and generates ideal action data on the basis of change amounts of the feature points between the first reference object image and the ideal object image. The apparatus extracts feature points from a second reference object image and an evaluation object image sensed by the image sensing unit, and generates measurement action data on the basis of change amounts of the feature points between the second reference object image and the evaluation object image. The movement evaluation apparatus evaluates the movement of the object in the evaluation object image on the basis of the ideal action data and the measurement action data.

### CLAIM OF PRIORITY

This application claims priority from Japanese Patent Application No. 2004-049935 filed on Feb. 25, 2004, which is hereby incorporated by reference herein.

### FIELD OF THE INVENTION

The present invention relates to a movement evaluation apparatus and method and, more particularly, to a technique suitable to evaluate facial expressions such as smile and the like.

### BACKGROUND OF THE INVENTION

As it is often said, in case of face-to-face communications such as counter selling and the like, the “business smile” is important to render a favorable impression, which, in turn, constitute a base for smoother communications. In light of this, the importance of smile is common knowledge and very important for sales people who should always be wearing one. However, some people are not good at contacting others with expressive looks, i.e., with a natural smile. A training apparatus and method to effectively train people to naturally smile could become an effective means, however, no proposals about such a training apparatus and method oriented towards natural smile training has been submitted yet.

In general, as it is done for sign language practices, and sports such as golf, ski, and the like, first the hand and body movements of a skilled persons are recorded on a video and the like, and then a user impersonates the movements while observing the recorded images. Japanese Patent Laid-Open No. 08-251577 discloses a system which captures the movements of a user with an image sensing means, and displays a model image of the skilled person together with the image of the user. Furthermore, Japanese Patent Laid-Open No. 09-034863 discloses a system which detects the hand movement of a user based on a data glove used by the user, recognizes sign language from that hand movement, and presents the recognition result through speech, images or text. With this system, the user practices sign language repeatedly until the intended is accurately recognized by the system.

However, one cannot expect to master skills by merely observing a model image recorded on a video or the like.

As disclosed in Japanese Patent Laid-Open No. 08-251577, even when the model image and the image of the user are displayed together, it is difficult for the user to determine whether or not that movement is correct. Furthermore, as disclosed in Japanese Patent Laid-Open No. 09-034863, the user can determine whether or not the meaning of sign language matches that recognized by the system. However, it is difficult for the user to determine to what extent his or her movement were correct when the intended meaning does not accurately match the recognition result of the system. In other words, if his corrections are good (on the right track) or wrong (backward).

### SUMMARY OF THE INVENTION

It is therefore an object of the present invention to easily evaluate a movement. It is another object of the present invention to allow the system to give advice to the user.

According to one aspect of the present invention, there is provided a movement evaluation apparatus comprising: an image sensing unit configured to sense an image including an object; a first generation unit configured to extract feature points from a reference object image and an ideal object image, and generating ideal action data on the basis of change amounts of the feature points between the first reference image and ideal object image; a second generation unit configured to extract feature points from a second reference object image and an evaluation object image sensed by the image sensing unit, and generating measurement action data on the basis of change amounts of the feature points between the second reference object image and the evaluation object image; and an evaluation unit configured to evaluate a movement of the object in the evaluation object image on the basis of the ideal action data and the measurement action data.

Furthermore, according to another aspect of the present invention, there is provided a movement evaluation method, which uses an image sensing unit which can sense an image including an object, comprising: a first generation step of extracting feature points from a first reference object image and an ideal object images, and generating ideal action data on the basis of change amounts of the feature points between the first reference object and the ideal object image; a second generation step of extracting feature points from a second reference object image and an evaluation object image sensed by the image sensing unit, and generating measurement action data on the basis of change amounts of the feature points between the second reference object image and the evaluation object image; and an evaluation step of evaluating a movement of the object in the evaluation object image on the basis of the ideal action data and the measurement action data.

In this specification, object movements include body movements and changes of facial expressions.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a block diagram showing the hardware arrangement of a smile training apparatus according to the first embodiment;

FIG. 1B is a block diagram showing the functional arrangement of the smile training apparatus according to the first embodiment;

FIG. 2 is a flowchart of an ideal smile data generation process in the first embodiment;

FIG. 3 is a flowchart showing the smile training process of the first embodiment;

FIG. 4 is a chart showing an overview of the smile training operations in the first and second embodiments;

FIG. 5 shows hierarchical object detection;

FIG. 6 shows a hierarchical neural network;

FIG. 7 is a view for explaining face feature points;

FIG. 8 shows an advice display example of smile training according to the first embodiment;

FIG. 9 is a block diagram showing the functional arrangement of a smile training apparatus according to the second embodiment;

FIG. 10 is a flowchart of an ideal smile data generation process in the second embodiment;

FIG. 11 is a view for explaining tools required to generate an ideal smile image;

FIG. 12 is a block diagram showing the functional arrangement of a smile training apparatus according to the third embodiment; and

FIG. 13 shows a display example of evaluation of a change in smile according to the third embodiment.

### DETAILED DESCRIPTION OF THE PREFERRED EMBODIMENTS

Preferred embodiments of the present invention will now be described in detail in accordance with the accompanying drawings.

### First Embodiment

The first embodiment will explain a case wherein the movement evaluation apparatus is applied to an apparatus for training the user to put on a smile.

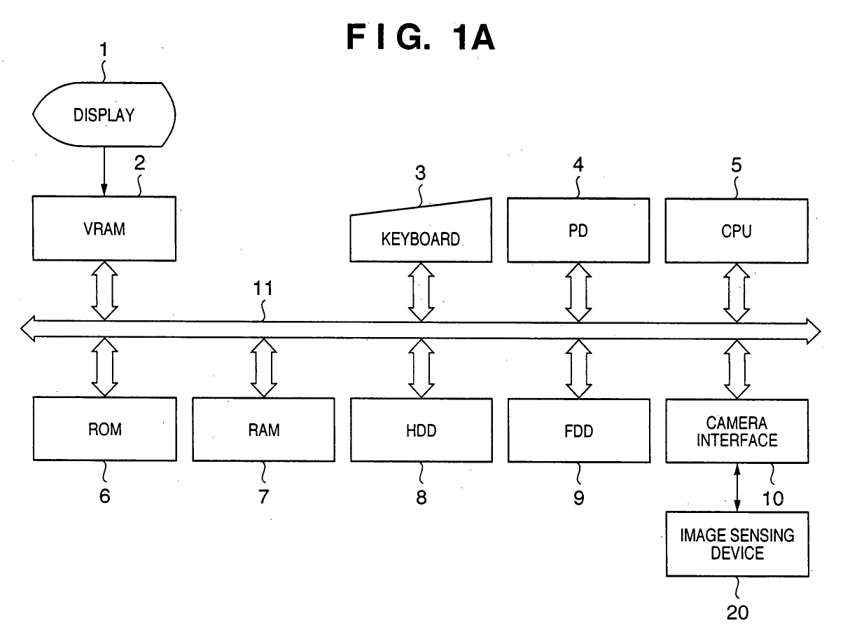

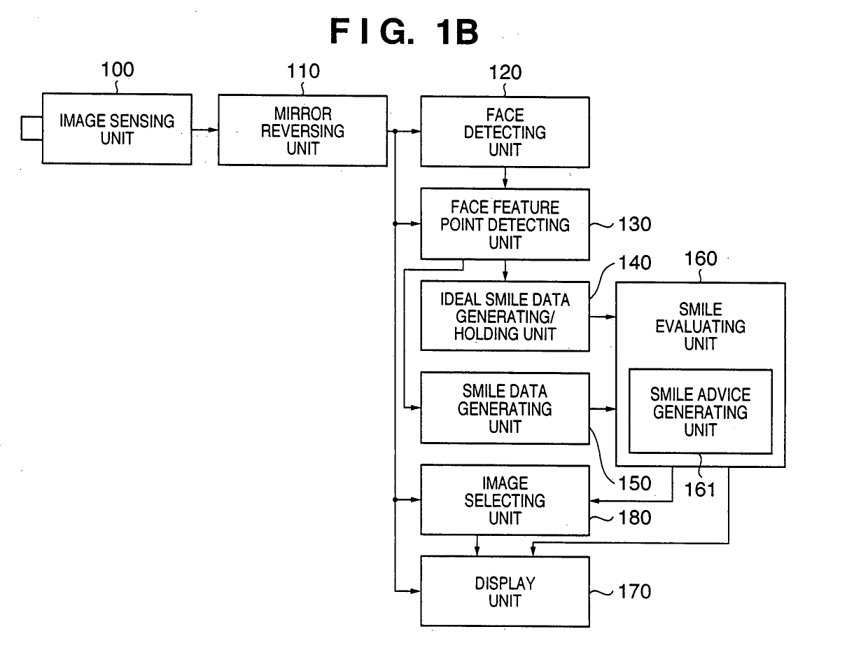

FIG. 1A is a block diagram showing the arrangement of a smile training apparatus according to this embodiment. A display 1 displays information of data which are being processed by an application program, various message menus, a video picture captured by an image sensing device 20, and the like. A VRAM 2 is a video RAM (to be referred to as a VRAM hereinafter) used to map images to be displayed on the screen of the display 1. Note that the type of the display 1 is not particularly limited (e.g., a CRT, LCD, and the like). A keyboard 3 and pointing device 4 are operation input means used to input text data and the like in predetermined fields on the screen, to point to icons and buttons on a GUI, and so forth. A CPU 5 controls the overall smile training apparatus of this embodiment.

A ROM 6 is a read-only memory, and stores the operation processing sequence (program) of the CPU 5. Note that this ROM 6 may store programs associated with the flowcharts to be described later in addition to application programs associated with data processes and error processing programs. A RAM 7 is used as a work area when the CPU 5 executes programs, and as a temporary save area in the error process. When a general-purpose computer apparatus is applied to the smile training apparatus of this embodiment, a control program required to execute the processes to be described later is loaded from an external storage medium onto this RAM 7, and is executed by the CPU 5.

A hard disk drive (to be abbreviated as HDD hereinafter) 8, and floppy® disk drive (to be abbreviated as FDD hereinafter) 9 form external storage media, and these disks are used to save and load application programs, data, libraries, and the like. Note that an optical (magnetic) disk drive such as a CD-ROM, MO, DVD, and the like, or a magnetic tape drive such as a tape streamer, DDS, and the like may be arranged in place of or in addition to the FDD.

A camera interface 10 is used to connect this apparatus to an image sensing device 20. A bus 11 includes address, data, and control buses, and interconnects the aforementioned units.

FIG. 1B is a block diagram showing the functional arrangement of the aforementioned smile training apparatus. The smile training apparatus of this embodiment has an image sensing unit 100, mirror reversing unit 110, face detecting unit 120, face feature point detecting unit 130, ideal smile data generating/holding unit 140, smile data generating unit 150, smile evaluating unit 160, smile advice generating unit 161, display unit 170, and image selecting unit 180. These functions are implemented when the CPU 5 executes a predetermined control program and utilizes respective hardware components (display 1, RAM 7, HDD 8, image sensing device 20, and the like).

The functions of the respective units shown in FIG. 1B will be described below. The image sensing unit 100 includes a lens and an image sensor such as a CCD or the like, and is used to sense an image. Note that the image to be provided from the image sensing unit 100 to this system may be continuous still images or a moving image (video image). The mirror reversing unit 110 mirror-reverses an image sensed by the image sensing unit 100. Note that the user can arbitrarily select whether or not an image is to be mirror-reversed. The face detecting unit 120 detects a face part from the input image. The face feature point detecting unit 130 detects a plurality of feature points from the face region in the input image detected by the face detecting unit 120.

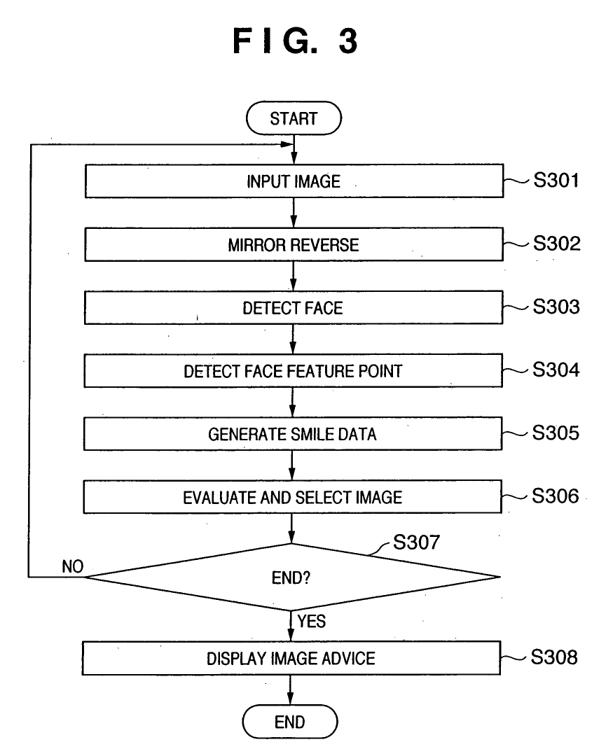

The ideal smile data generating/holding unit 140 generates and holds ideal smile data suited to an object's face. The smile data generating unit 150 generates smile data from the face in the second image. The smile evaluating unit 160 evaluates a similarity level of the object's face by comparing the smile data generated by the smile data generating unit 150 with the ideal smile data generated and held by the ideal smile data generating/holding unit 140. The smile advice generating unit 161 generates advice for the object's face on the basis of this evaluation result. The display unit 170 displays the image and the advice generated by the smile advice generating unit 161. The image selecting unit 180 selects and holds one image on the basis of the evaluation results of the smile evaluating unit 160 for respective images sensed by the image sensing unit 100. This image is used to generate the advice, and this process will be described later using FIG. 3 (step S306).

The operation of the smile training apparatus with the above arrangement will be described below. The operation of the smile training apparatus according to this embodiment is roughly divided into two operations, i.e., the operation upon generating ideal smile data (ideal smile data generation process) and that upon trailing a smile (smile training process).

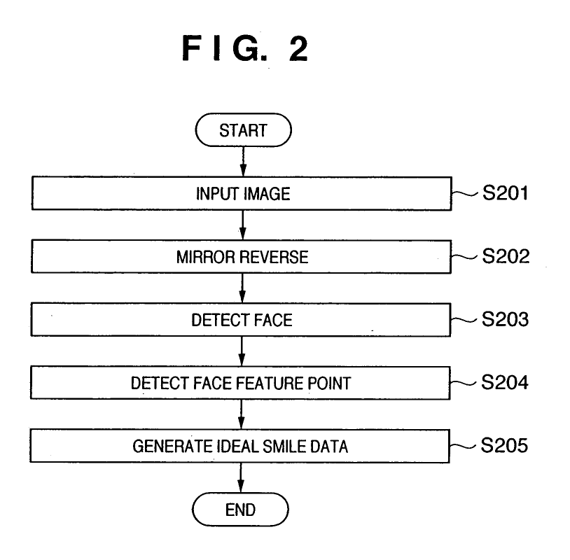

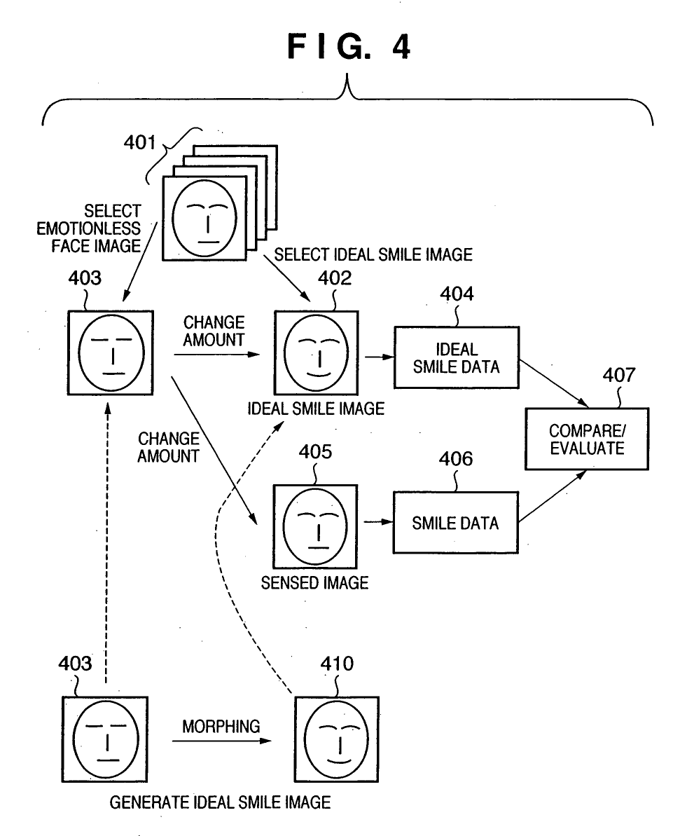

The operation upon generating ideal smile data will be described first using the flowchart of FIG. 2 and FIG. 4.

In step S201, the system prompts the user to select a face image (402) which seems to be an ideal smile image, and an emotionless face image (403) from a plurality of face images (401 in FIG. 4) obtained by sensing the object's face by the image sensing unit 100. In case of a moving image, frame images are used. In step S202, the mirror reversing unit 110 mirror-reverses the image sensed by the image sensing unit 100. Note that this reversing process may or may not be done according to the favor of the object, i.e., the user. When an image obtained by sensing the object is mirror-reversed, and is displayed on the display unit 170, an image of the face in the mirror is displayed. Therefore, when the sensed, mirror-reversed image and advice “raise the right end of the lips” are displayed on the display unit, the user can easily follow such advice. However, since a face that another person looks upon facing that person in practice is the image which is not mirror-reversed, some users want to train using such non-mirror-reversed images. Hence, for example, the user can train using mirror-reversed images early on the training, and can then use non-mirror-reversed images. For the reasons described above, the mirror-reversing process can be selected in step S202.

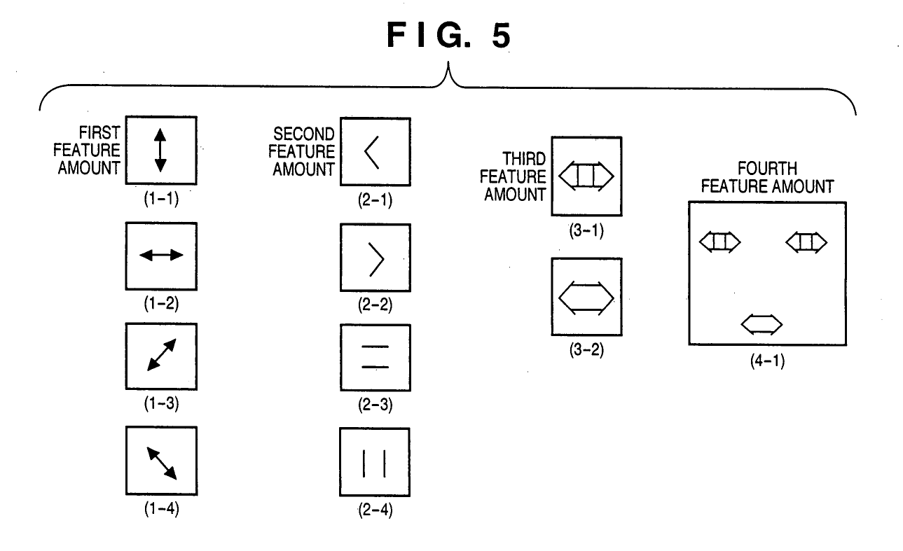

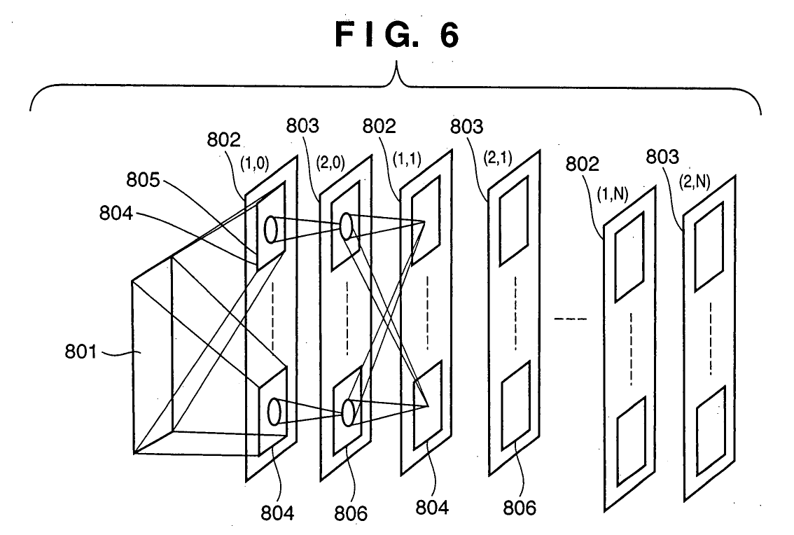

In step S203, the face detecting unit 120 executes a face detecting process of the image which is mirror-reversed or not reversed in step S202. This face detecting process will be described below using FIGS. 5 and 6.

FIG. 5 illustrates an operation for finally detecting a face as an object by hierarchically repeating a process for detecting local features, integrating the detection results, and detecting local features of the next layer. That is, first features as primitive features are detected first, and second features are detected using the detection results (detection levels and positional relationship) of the first features. Third features are detected using the detection results of the second features, and a face as a fourth feature is finally detected using the detection results of the third features.

FIG. 5 shows examples of first features to be detected. Initially, features such as a vertical feature (1-1), horizontal feature (1-2), upward slope feature (1-3), and downward slope feature (1-4) are to be detected. Note that the vertical feature (1-1) represents an edge segment in the vertical direction (the same applies to other features). This detection result is output in the form of a detection result image having a size equal to that of the input image for each feature. That is, in this example, four different detection result images are obtained, and whether or not a given feature is present at that position of the input image can be confirmed by checking the value of the position of the detection result image of each feature. A right side open v-shaped feature (2-1), left side open v-shaped feature (2-2), horizontal parallel line feature (2-3), and vertical parallel line feature (2-4) as second features are respectively detected as follows: the right side open v-shaped feature is detected based of the upward slope feature and downward slope feature, the left side open v-shaped feature is detected based on the downward slope feature and upward slope feature, the horizontal parallel line feature is detected based on the horizontal features, and the vertical parallel line feature is detected based on the vertical features. An eye feature (3-1) and mouth feature (3-2) as third features are respectively detected as follows: the eye feature is detected based on the right side open v-shaped feature, left side open v-shaped feature, horizontal parallel line feature, and vertical parallel line feature, and the mouth feature is detected based on the right side open v-shaped feature, left side open v-shaped feature, and the horizontal parallel line feature. A face feature (4-1) as the fourth feature is detected based on the eye feature and mouth feature.

As described above, the face detecting unit 120 detects primitive local features first, hierarchically detects local features using those detection results, and finally detects a face as an object. Note that the aforementioned detection method can be implemented using a neural network that performs image recognition by parallel hierarchical processes, and this process is described in M. Matsugu, K. Mori, et.al, “Convolutional Spiking Neural Network Model for Robust Face Detection”, 2002, International Conference On Neural Information Processing (ICONIP02).

The processing contents of the neural network will be described below with reference to FIG. 6. This neural network hierarchically handles information associated with recognition (detection) of an object, geometric feature, or the like in a local region of input data, and its basic structure corresponds to a so-called Convolutional network structure (LeCun, Y. and Bengio, Y., 1995, “Convolutional Networks for Images Speech, and Time Series” in Handbook of Brain Theory and Neural Networks (M. Arbib, Ed.), MIT Press, pp. 255-258). The final layer (uppermost layer) can obtain the presence/absence of an object to be detected, and position information of that object on the input data if it is present.

A data input layer 801 is a layer for inputting image data. A first feature detection layer 802 (1, 0) detects local, low-order features (which may include color component features in addition to geometric features such as specific direction components, specific spatial frequency components, and the like) at a single position in a local region having, as the center, each of positions of the entire frame (or a local region having, as the center, each of predetermined sampling points over the entire frame) at a plurality of scale levels or resolutions in correspondence with the number of a plurality of feature categories.

A feature integration layer 803 (2, 0) has a predetermined receptive field structure (a receptive field means a connection range with output elements of the immediately preceding layer, and the receptive field structure means the distribution of connection weights), and integrates (arithmetic operations such as sub-sampling by means of local averaging, maximum output detection or the like, and so forth) a plurality of neuron element outputs in identical receptive fields from the feature detection layer 802 (1, 0). This integration process has a role of allowing positional deviations, deformations, and the like by spatially blurring the outputs from the feature detection layer 802 (1, 0). Also, the receptive fields of neurons in the feature integration layer have a common structure among neurons in a single layer.

Respective feature detection layers 802 ((1, 1), (1, 2), . . . , (1, M)) and respective feature integration layers 803 ((2, 1), (2, 2), . . . , (2, M)) are subsequent layers, the former layers ((1, 1), . . . ) detect a plurality of different features by respective feature detection modules as in the aforementioned layers, and the latter layers ((2, 1), . . . ) integrate detection results associated with a plurality of features from the previous feature detection layers. Note that the former feature detection layers are connected (wired) to receive cell element outputs of the previous feature integration layers that belong to identical channels. Sub-sampling as a process executed by each feature integration layer performs averaging and the like of outputs from local regions (local receptive fields of corresponding feature integration layer neurons) from a feature detection cell mass of an identical feature category.

In order to detect respective features shown in FIG. 5, the receptive field structure used in detection of each feature detection layer shown in FIG. 6 is designed to detect a corresponding feature, thus allowing detection of respective features. Also, receptive field structures used in face detection in the face detection layer as the final layer are prepared to be suited to respective sizes and rotation amounts, and face data such as the size, direction, and the like of a face can be obtained by detecting which of receptive field structures is used in detection upon obtaining the result indicating the presence of the face.

In step S203, the face detecting unit 120 executes the face detecting process by the aforementioned method. Note that this face detecting process is not limited to the above specific method. In addition to the above method, the position of a face in an image can be obtained using, e.g., Eigen Face or the like.

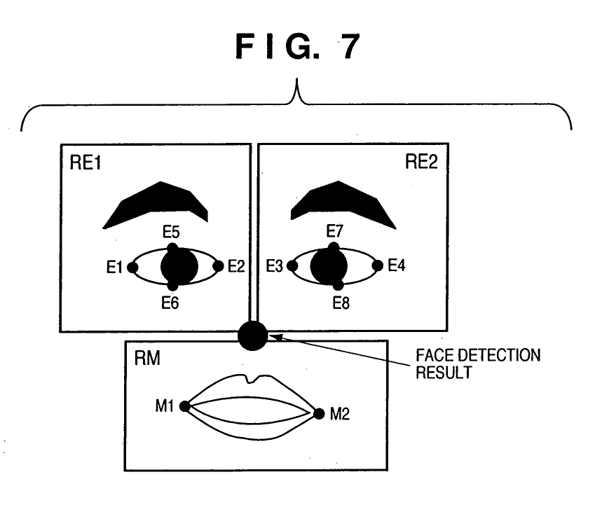

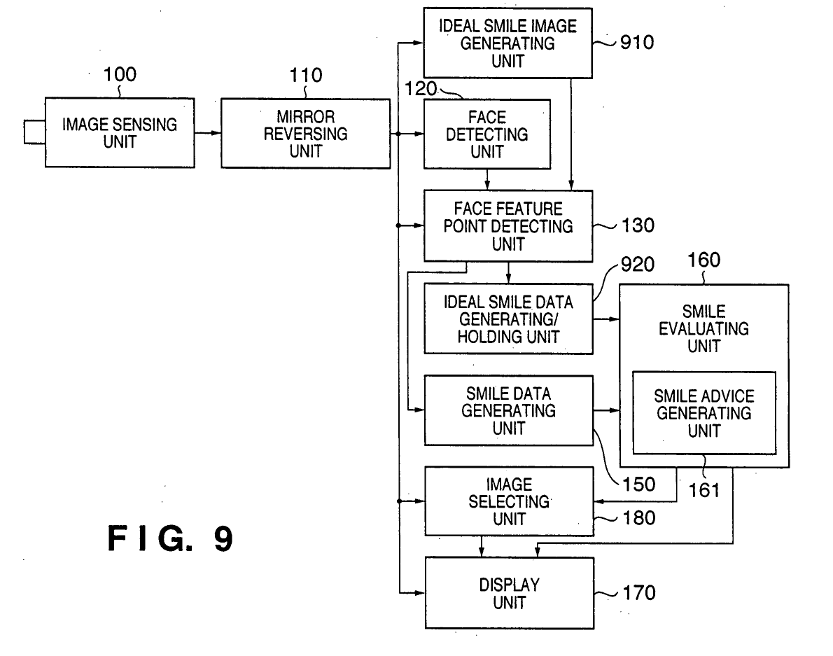

In step S204, the face feature point detecting unit 130 detects a plurality of feature points from the face region detected in step S203. FIG. 7 shows an example of feature points to be detected. In FIG. 7, reference numerals E1 to E4 denote eye end points; E5 to E8, eye upper and lower points; and M1 and M2, mouth end points. Of these feature points, the eye end points E1 to E4 and mouth end points M1 and M2 correspond to the right side open v-shaped feature (2-1) and left side open v-shaped feature (2-2) as the second features shown in FIG. 5. That is, these end points have already been detected in the intermediate stage of face detection in step S203. For this reason, the features shown in FIG. 7 need not be detected anew. However, the right side open v-shaped feature (2-1) and left side open v-shaped feature (2-2) in the image are present at various locations such as a background and the like in addition to the face. Hence, the brow, eye, and mouth end points of the detected face must be detected from the intermediate results obtained by the face detecting unit 102. As shown in FIG. 9, search areas (RE1, RE2) of the brow and eye end points and that (RM) of the mouth end points are set with reference to the face detection result. Then, the eye and mouth end points are detected within the set areas from the right side open v-shaped feature (2-1) and left side open v-shaped feature (2-2).

The detection method of the eye upper and lower points (E5 to E8) is as follows. A middle point of the detected end points of each of the right and left eyes is obtained, and edges are searched for from the middle point position in the up and down directions, or regions where the brightness largely changes from dark to light or vice versa are searched for. Middle points of these edges or the regions where the brightness largely change are defined as the eye upper and lower points (E5 to E8).

In step S205, the ideal smile data generating/holding unit 140 searches the selected ideal smile image (402) for the above feature points, and generates and holds ideal smile data (404), as will be described below.

Compared to an emotionless face, a good smile has changes: 1. the corners of the mouth are raised; and 2. the eyes are narrowed. In addition, some persons have laughter lines or dimples when they smile, but such features largely depend on individuals. Hence, this embodiment utilizes the aforementioned two changes. More specifically, the change “the corners of the mouth are raised” is detected based on changes in distance between the eye and mouth end points (E1-M1 and E4-M2 distances) detected in the face feature point detection in step S204. Also, the change “the eyes are narrowed” is detected based on changes in distance between the upper and lower points of the eyes (E5-E6 and E7-E8 distances) similarly detected in step S204. That is, the features required to detect these changes have already been detected in the face feature point detecting process in step S204.

In step S205, with respect to the selected ideal smile image (402), the rates of change of the distances between the eye and mouth end points and distances between the upper and lower points of the eyes detected in step S204 to those on the emotionless face image (403) are calculated as ideal smile data (404). That is, this ideal smile data (404) indicates how much the distances between the eye and mouth end points and distances between the upper and lower points of the eyes detected in step S204 have changed with respect to those on the emotionless face when an ideal smile is obtained. Upon comparison, the distances to be compared and their change amounts are normalized with reference to the distance between the two eyes of each face and the like.

In this embodiment, a total of two rates of change between the distances between the eye and mouth end points on the right and left sides, and a total of two change amounts of the distances between the upper and lower points of the eyes on the right and left sides are obtained between the ideal smile (402) and emotionless face (403). Hence, these four change amounts are held as ideal smile data (404).

After the ideal smile data (404) is generated in this way, it is ready for starting smile training. FIG. 3 is a flowchart showing the operation upon smile training. The operation upon training will be described below with reference to FIGS. 3 and 4.

In step S301, a face image (405) is acquired by sensing an image of an object who is smiling during smile training by the image sensing unit 100. In step S302, the image sensed by the image sensing unit 100 is mirror-reversed. However, this reversing process may or may not be done according to the favor of the object, i.e., the user as in the ideal smile data generation process.

In step S303, the face detecting process is applied to the image which is mirror-reversed or not reversed in step S302. In step S304, the eye and mouth end points and the eye upper and lower points, i.e., face feature points are detected as in the ideal smile data generation process. In step S305, the rates of change of the distances of the face feature points detected in step S304, i.e., the distances between the eye and mouth end points and distances between the upper and lower points of the eyes on the face image 405 to those on the emotionless face (403), are calculated, and are defined as smile data (406 in FIG. 4).

In step S306, the smile evaluating unit 160 compares (407) the ideal smile data (404) and smile data (406). More specifically, the unit 160 calculates the differences between the ideal smile data 404) and smile data (406) in association with the change amounts of the distances between the right and left eye end points and mouth end points, and those of the distances of the upper and lower points of the right and left eyes, and calculates an evaluation value based on these differences. At this time, the evaluation value can be calculated by multiplying the differences by predetermined coefficient values. The coefficient values are set depending on the contribution levels of eye changes and mouth corner changes on a smile. For example, in general, when the mouth corner changes are recognized as a smile rather than the eye changes, the contribution level of the mouth corner changes is larger. Hence, the coefficient value for the differences of the rates of change of the mouth corners is set to be higher than that for the differences of the rates of change of the eyes. When the evaluation value becomes equal to or lower than a predetermined threshold value, an ideal smile is determined. In step S306, of images whose evaluation values calculated during this training become equal to or lower than the threshold value, an image that exhibits a minimum value is held as an image (advice image) to which advice is to be given. As an advice image, an image the prescribed number of images (e.g., 10 images) after the evaluation value becomes equal to lower than the threshold value first, or an intermediate image of those which have evaluation values equal to or lower than the threshold values may be selected.

It is checked in step S307 if this process is to end. It is determined in this step that the process is to end when the evaluation values monotonously decrease, or assume values equal to or lower than the threshold value across a predetermined number of images. Otherwise, the flow returns to step S301 to repeat the aforementioned process.

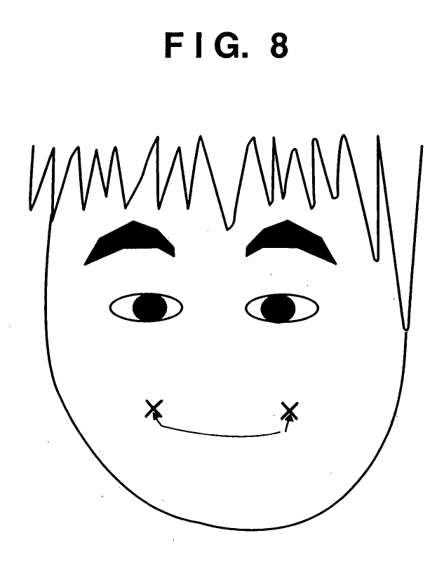

In step S308, the smile advice generating unit 161 displays the image selected in step S306, and displays the difference between the smile data at that time and the ideal smile data as advice. For example, as shown in FIG. 8, arrows are displayed from the feature points on the image selected and saved in step S306 to ideal positions of the mouth end points or those of the upper and lower points of the eyes obtained based on the ideal smile data. These arrows give advice for the user that he or she can change the mouth corners or eyes in the directions of these arrows.

As described above, according to this embodiment, ideal smile data suited to an object is obtained, and smile training that compares that ideal smile data with smile data obtained from a smile upon trailing and evaluates the smile can be made. Since face detection and face feature point detection are automatically done, the user can easily train. Since the ideal smile data is compared with a smile upon training, and overs and shorts of the change amounts are presented in the form of arrows as advice to the user, the user can easily understood whether or not his or her movement has been corrected correctly.

In general, since an ideal action suited to an object is compared with an action upon training, that action can be efficiently trained. Also, since feature points required for evaluation are automatically detected, the user can easily train. Since the ideal action is compared with that upon training and overs and shorts of change amounts are presented as advice to the user, the user can easily understood whether or not his or her movement has been corrected correctly.

In this embodiment, the user selects an ideal smile image in step S201. Alternatively, ideal smile data suited to an object may be automatically selected using ideal smile parameters calculated from a large number of smile images. In order to calculate such ideal smile parameters, changes (changes in distance between the eye and mouth end points and in distance between the upper and lower points of the eyes) used in smile detection are sampled from many people, and the averages of such changes may be used as ideal smile parameters. In this embodiment, an emotionless face and an ideal smile are selected from images sensed by the image sensing unit 100. But the emotionless face may be acquired during smile training. On the other hand, since the ideal smile data are a normalized data as described above, the ideal smile data can be generated using the emotionless face image and smile image of another person, e.g., an ideal smile model. That is, the user can train to be able to smile like a person who smiles the way the user wants to. In this case, it is not necessary to sense user's face before starting the smile training.

In this embodiment, arrows are used as the advice presentation method. As another presentation method, high/low pitches or large/small volume levels of tones may be used. In this embodiment, smile training has been explained. However, the present invention can be used in training of other facial expressions such as a sad face and the like. In addition to facial expressions, the present invention can be used to train actions such as a golf swing arc, pitching form, and the like.

### Second Embodiment

FIG. 9 is a block diagram showing the functional arrangement of a smile training apparatus according to the second embodiment. Note that the hardware arrangement is the same as that shown in FIG. 1A. Also, the same reference numerals in FIG. 9 denote the same functional components as those in FIG. 1B. As shown in FIG. 9, the smile training apparatus of the second embodiment has an image sensing unit 100, mirror reversing unit 110, ideal smile image generating unit 910, face detecting unit 120, face feature point detecting unit 130, ideal smile data generating/holding unit 920, smile data generating unit 150, smile evaluating unit 160, smile advice generating unit 161, display unit 170, and image selecting unit 180.

A difference from the first embodiment is the ideal smile image generating unit 910. In the first embodiment, when the ideal smile data generating/holding unit 140 generates ideal smile data, an ideal smile image is selected from sensed images, and the ideal smile data is calculated from that image. By contrast, in the second embodiment, the ideal smile image generating unit 910 generates an ideal smile image by using (modifying) the input (sensed) image. The ideal smile data generating/holding unit 920 generates ideal smile data as in the first embodiment using the ideal smile image generated by the ideal smile image generating unit 910.

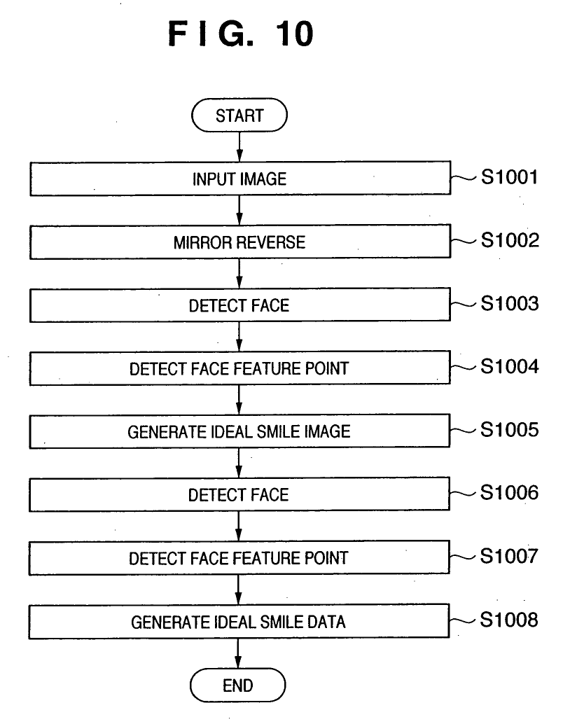

The operation upon generating ideal smile data (ideal smile data generation process) in the arrangement shown in FIG. 9 will be described with reference to the flowchart of FIG. 10.

In step S1001, the image sensing unit 100 senses an emotionless face (403) of an object. In step S1002, the image sensed by the image sensing unit 100 is mirror-reversed. However, as has been described in the first embodiment, this reversing process may or may not be done according to the favor of the object, i.e., the user. In step S103, the face detecting process is applied to the image which is mirror-reversed or not reversed in step S1002. In step S1004, the face feature points (the eye and mouth end points and upper and lower points of the eyes) of the emotionless face image are detected.

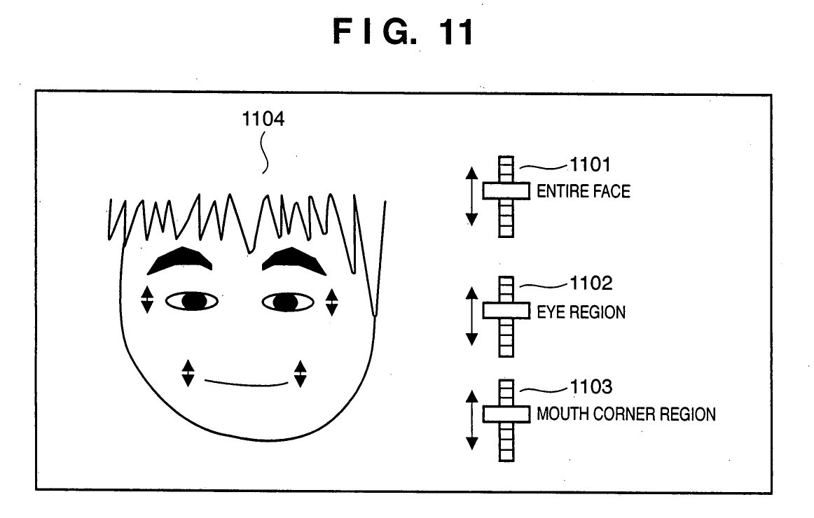

In step S1005, an ideal smile image (410) that the user wants to be is generated by modifying the emotionless image using the ideal image generating unit 910. For example, FIG. 11 shows an example of a user interface provided by the ideal image generating unit 910. As shown in FIG. 11, an emotionless face image 1104 is displayed together with graphical user interface (GUI) controllers 1101 to 1103 that allow the user to change the degrees of change of respective regions of the entire face, eyes, and mouth corners. The user can change, for example, the mouth corners of the face image 1104 (by operating the controller 1103) using this GUI. At this time, a maximum value of the change amount that can be designated may be set to be a value determined based on smile parameters calculated from data in large quantities as in the first embodiment, and a minimum value of the change amount may be set to be changeless, i.e., that of the emotionless face image intact.

Note that a morphing technique can be used to generate an ideal smile image by adjusting the GUI. When the maximum value of the change amount may be set to be a value determined based on smile parameters calculated from data in large quantities as in the first embodiment, an image that has undergone the maximum change can be generated using the smile parameters. Hence, when an intermediate value is set as the change amount, a face image with the intermediate change amount is generated by the morphing technique using the emotionless face image and the image with the maximum change amount.

In step S1006, the face detecting process is applied to the ideal smile image generated in step S1005. In step S1007, the eye and mouth end points and upper and lower points of the eyes on the face detected in step S1006 are detected from the ideal smile image generated in step S1005. In step S1008, the change amounts of the distances between the eye and mouth end points and distances between the upper and lower points of the eyes on the emotionless face image detected in step S1004 to those on the ideal smile image detected in step S1007 are calculated as ideal smile data.

Since the smile training processing sequence using the ideal smile data generated in this way is the same as that in the first embodiment, a description thereof will be omitted.

As described above, according to the second embodiment, since an ideal smile image can be acquired when the user generates that image in place of acquiring the ideal smile image by image sensing, trailing for a desired smile can be easily done. As can be seen from the above description, the arrangement of the second embodiment can be applied to evaluation of actions other than a smile as in the first embodiment.

### Third Embodiment

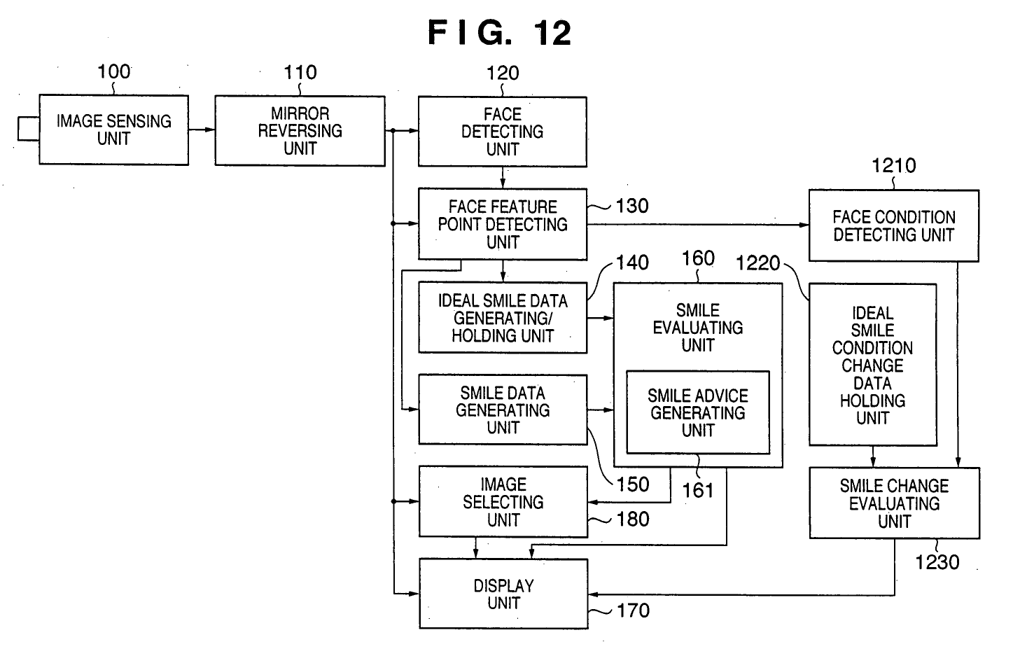

FIG. 12 is a block diagram showing the functional arrangement of a smile training apparatus of the third embodiment. The smile training apparatus of the third embodiment comprises an image sensing unit 100, mirror reversing unit 110, face detecting unit 120, face feature point detecting unit 130, ideal smile data generating/holding unit 140, smile data generating unit 150, smile evaluating unit 160, smile advice generating unit 161, display unit 170, image selecting unit 180, face condition detecting unit 1210, ideal smile condition change data holding unit 1220, and smile change evaluating unit 1230. Note that the hardware arrangement is the same as that shown in FIG. 1A.

Unlike in the first embodiment, the face condition detecting unit 1210, ideal smile condition change data holding unit 1220, and smile change evaluating unit 1230 are added. The first embodiment evaluates a smile using references “the corners of the mouth are raised” and “the eyes are narrowed”. By contrast, the third embodiment also uses, in evaluation, the order of changes in feature point of the changes “the corners of the mouth are raised” and “the eyes are narrowed”. That is, temporal elements of changes in feature points are used for the evaluation.

For example, smiles include “smile of pleasure” that a person wears when he or she is happy, “smile of unpleasure” that indicates derisive laughter, and “social smile” such as a constrained smile or the like. In these smiles, the mouth corners are raised and the eyes are narrowed finally. These smiles can be distinguished from each other by timings when the mouth corners are raised and the eyes are narrowed. For example, the mouth corners are raised, and the eyes are then narrowed when a person wears a “smile of pleasure”, while the eyes are narrowed and the mouth corners are then raised when a person wears a “smile of unpleasure”. When a person wears a “social smile”, the mouth corners are raised nearly simultaneously when the eyes are narrowed.

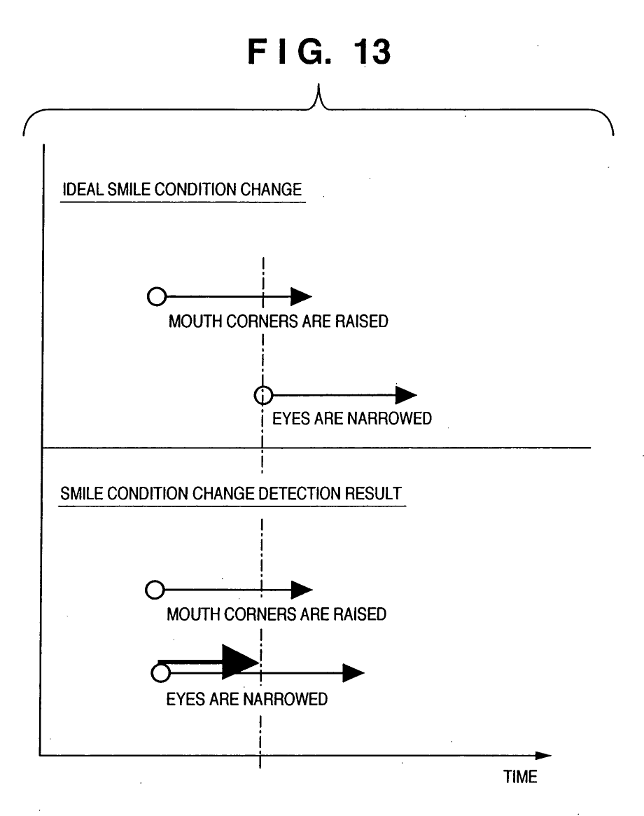

The face condition detecting unit 1210 of the third embodiment detects the face conditions, i.e., the changes “the mouth corners are raised” and “the eyes are narrowed”. The ideal smile condition change data holding unit 1220 holds ideal smile condition change data. That is, the face condition detecting unit 1210 detects the face conditions, i.e., the changes “the mouth corners are raised” and “the eyes are narrowed”, and the smile change evaluating unit 1230 evaluates if the order of these changes matches that of the ideal smile condition changes held by the ideal smile condition change data holding unit 1220. The evaluation result is then displayed on the display unit 170. FIG. 13 shows an example of such display. FIG. 13 shows the timings of the changes “the mouth corners are raised” and “the eyes are narrowed” in case of the ideal smile condition changes in the upper graph, and the detection results of the smile condition changes in the lower graph. As can be understood from FIG. 13, the change “the eyes are narrowed” ideally starts from an intermediate timing of the change “the mouth corners are raised”, but they start at nearly the same timings in an actual smile. In this manner, the movement timings of the respective parts of the ideal and actual cases are displayed and advice that delays the timing of the change “the eyes are narrowed” is indicated by an arrow in the example shown in FIG. 13.

With this arrangement, according to this embodiment, the process to a smile can also be evaluated, and the user can train a pleasant smile.

In this embodiment, smile training has been explained. However, the present invention can be used in training of other facial expressions such as a sad face and the like. In addition to facial expressions, the present invention can be used to train actions such as a golf swing arc, pitching form, and the like. For example, the movement timings of the shoulder line and wrist are displayed, and can be compared with an ideal form. In order to obtain a pitching form, the movement of a hand can be detected by detecting the hand from frame images of a moving image which is sensed at given time intervals. The hand can be detected by detecting a flesh color (it can be distinguished from a face since the face can be detected by another method), or a color of the glove. In order check a golf swing, a club head is detected by attaching, e.g., a marker of a specific color to that club head to obtain a swing arc. In general, a moving image is divided into a plurality of still images, required features are detected from respective images, and a two-dimensional arc can be obtained by checking changes in coordinate of the detected features among a plurality of still images. Furthermore, a three-dimensional arc can be detected using two or more cameras.

As described above, according to each embodiment, smile training that compares the ideal smile data suited to an object with smile data obtained from a smile upon trailing and evaluates the smile can be made. Since face detection and face feature point detection are automatically done, the user can easily train. Since the ideal smile data is compared with a smile upon training, and overs and shorts of the change amounts are presented in the form of arrows as advice to the user, the user can easily understood whether or not his or her movement has been corrected correctly.

Note that the objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a flexible disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

According to the embodiments mentioned above, movements can be easily evaluated. The system can give advice to the user.

As many apparently widely different embodiments of the present invention can be made without departing from the spirit and scope thereof, it is to be understood that the invention is not limited to the specific embodiments thereof except as defined in the appended claims.

1. A movement evaluation apparatus comprising:
an image sensing unit configured to sense an image including an object;
a first generation unit configured to extract feature points from a reference object image and an ideal object image, and generating ideal action data on the basis of change amounts of the feature points between the first reference image and ideal object image;
a second generation unit configured to extract feature points from a second reference object image and an evaluation object image sensed by said image sensing unit, and generating measurement action data on the basis of change amounts of the feature points between the second reference object image and the evaluation object image; and
an evaluation unit configured to evaluate a movement of the object in the evaluation object image on the basis of the ideal action data and the measurement action data.

2. The apparatus according to claim 1, wherein said first and second generation unit extract face parts from the object images, and extract the features points from the face parts, and
said evaluation unit evaluates a movement of a face of the object.

3. The apparatus according to claim 1, further comprising a selection unit configured to select an image to be used as the ideal object image from a plurality of object images sensed by said image sensing unit.

4. The apparatus according to claim 1, further comprising an acquisition unit configured to extract a plurality of feature points from each of a plurality of object images sensed by said image sensing unit, and acquiring, as the ideal object image, an object image in which a positional relationship of the plurality of feature points matches or is most approximate to a predetermined positional relationship.

5. The apparatus according to claim 1, further comprising a generation unit configured to generate the ideal object image by deforming an object image sensed by said image sensing unit.

6. The apparatus according to claim 1, further comprising a reversing unit configured to mirror-reverse an object image sensed by said image sensing unit.

7. The apparatus according to claim 1, further comprising:
an advice generation unit configured to generate advice associated with the movement of the object on the basis of the measurement ideal data and the ideal action data; and
a display unit configured to display the evaluation object image and the advice generated by said advice generation unit.

8. The apparatus according to claim 7, wherein the evaluation process of said evaluation unit is applied to each of a group of object images continuously sensed by said image sensing unit as the evaluation object image, and
said advice generation unit and said display unit are allowed to function using an object image that exhibits the best evaluation result.

9. The apparatus according to claim 1, further comprising a detection unit configured to extract a plurality of feature points from each of a group of object images continuously sensed by said image sensing unit, and detect movements of the plurality of feature points in the group of object images, and
wherein said evaluation unit evaluates the object movements on the basis of movement timings of the plurality of feature points detected by said detection unit.

10. The apparatus according to claim 9, further comprising a holding unit configured to hold data indicating reference timings of the movement timings of the plurality of feature points, and
wherein said evaluation unit evaluates the object movements by comparing the data indicating the reference timings held by said holding unit, and the movement timings of the plurality of feature points detected by said detection unit.

11. The apparatus according to claim 10, further comprising a display unit configured to comparably display the reference timings and the timings detected by said detection unit.

12. The apparatus according to claim 1, wherein the second reference object image is used as the first reference object image.

13. The apparatus according to claim 1, wherein images of a person different from the second reference object image and the evaluation object image are used as the first reference object image and the ideal object image.

14. A movement evaluation method, which uses an image sensing unit which can sense an image including an object, comprising:
a first generation step of extracting feature points from a first reference object image and an ideal object images, and generating ideal action data on the basis of change amounts of the feature points between the first reference object and the ideal object image;
a second generation step of extracting feature points from a second reference object image and an evaluation object image sensed by the image sensing unit, and generating measurement action data on the basis of change amounts of the feature points between the second reference object image and the evaluation object image; and
an evaluation step of evaluating a movement of the object in the evaluation object image on the basis of the ideal action data and the measurement action data.

15. A control program for making a computer execute a method of claim 14.

16. A storage medium storing a control program for making a computer execute a method of claim 14.
